(19) United States
(12) Patent Application Publication
(10) Pub. No.: US 2015/0116358 A1
(43) Pub. Date: Apr. 30, 2015

(54) APPARATUS AND METHOD FOR PROCESSING METADATA IN AUGMENTED REALITY SYSTEM

(71) Applicant: Electronics and Telecommunications Research Institute, Daejeon (KR)

(72) Inventors: Bum Suk CHOI, Daejeon (KR); Soon Choul KIM, Daejeon (KR); Jeoung Lak HA, Daejeon (KR); Young Ho JEONG, Daejeon (KR); Jin Woo HONG, Daejeon (KR)

(21) Appl. No.: 14/524,161

(22) Filed: Oct. 27, 2014

(30) Foreign Application Priority Data
Oct. 25, 2013 (KR) 10-2013-0127893
Oct. 10, 2014 (KR) 10-2014-0136848

(51) Int. Cl. G06T 19/00; G06T 11/60

(52) U.S. Cl. CPC G06T 19/006; G06T 11/60
USPC 345/633

(57) ABSTRACT

An apparatus for processing metadata includes: a map node defining component configured to define a map node for setting a virtual map; a map overlay node defining component configured to define a map overlay node for setting a layer in which an augmented reality object is to be overlaid on a map set according to the map node; a map marker node defining component configured to define a map marker node for setting a position of the augmented reality object on the map, which is to be overlaid on the layer set according to the map overlay node; a point of interest node defining component configured to set information on a point of interest, which is a position of the augmented reality object on the map; and a controller configured to load the virtual map, the layer, the map marker, and the point of interest.

### CROSS-REFERENCE TO RELATED APPLICATION(S)

This application claims priority from Korean Patent Application Nos. 10-2013-0127893, filed on Oct. 25, 2013, and 10-2014-0136848, filed on Oct. 10, 2014, in the Korean Intellectual Property Office, the entire disclosures of which are incorporated herein by references for all purposes.

### BACKGROUND

1. Field

The following description relates generally to a data processing technique, and more particularly to an apparatus and method for processing metadata in a map-based augmented reality navigation system implemented based on an MPEG-4 Binary Format for Scene (BIFS).

2. Description of the Related Art

Augmented reality (AR) refers to a technology that combines virtual objects or information with a real environment to make the virtual objects look as if they exist in a real environment. That is, AR is a technology that overlays three-dimensional (3D) virtual objects on a real world image. Unlike conventional virtual reality (VR) that provides only virtual spaces and objects, AR synthesizes virtual objects based on the real world to provide additional information that is hard to obtain in the real world. For this reason, AR may be applied in various actual environments, while a conventional virtual reality is used only in a limited field, such as a game. Particularly, the AR technology is in the spotlight as a next-generation display technology suitable for a ubiquitous environment.

A navigation system is a system for providing road and transportation information, in which an optimal path may be provided in consideration of a transportation status and distance from a current location to a destination. Such navigation system is being widely used for its convenience and versatility. While the navigation system may be implemented in various forms, it is generally configured in such a manner that a GPS receiver receives location information of a current vehicle from four or more satellites, and displays the location information on a 2-dimensional screen map by using electronic map data established in advance and using a map matching technique. However, such method has drawbacks in that when an electronic map is output to a screen in real time, an accurate field of view may not be obtained in an actual moving direction of a vehicle, with unnecessary information also being displayed, and image data may not be timely loaded according to a moving speed, thereby causing incongruity between an actual object and an image displayed on a screen, as well as inconvenience due to a difference between an actual 3D environment and a 2D plane map.

In order to solve the above problems, a 3D electronic map has been introduced. However, the 3D electronic map also has problems in that it is difficult to produce and modify a 3D map, which has high production costs, and greater map data space is required than a 2D electronic map, thereby requiring a greater deal of information processing in a location updating process, and easily causing incongruity between an actual environment and a 3D image on a screen. For this reason, a navigation utilizing augmented reality has been developed.

A navigation system utilizing augmented reality is a navigation system that captures images of roads of a moving vehicle by using a camera mounted on the vehicle, and overlays virtual paths on the captured images of roads. That is, the AR navigation system displays a destination or a position of interest by using a GPS sensor, a magnetic field sensor, an orientation sensor, and the like, based on actual images in the background captured through a camera.

The Moving Picture Experts Group (MPEG) aims at producing standards for compressing and coding moving images, and conducts researches on methods of transmitting information by compressing and coding images that are consecutively changed according to elapsed time. For example, MPEG-1 relates to a standardization technique for compressing and restoring moving images and audio data included in the moving images in digital storage media; MPEG-2 focuses on a technology for transmitting multimedia data; MPEG-4 relates to a technology for defining multimedia data in an object-based framework; MPEG-7 relates to a technology related to a method for representing multimedia data; and MPEG-21 relates to a technology for managing production, distribution, security and the like, of multimedia content.

The MPEG defines a standard technology for providing augmented reality services based on the MPEG-4 BIFS (ISO/IEC 23000-13). An augmented reality navigation system may be implemented by using map-related nodes adopted by the standard. An augmented reality application format (ARAF) is an expanded version of the MPEG-4 BIFS, and an initial standard specification of MPEG-ARAF has been approved, in which map-related nodes for providing an augmented reality navigation system are defined. These nodes are operated in such a manner that a virtual map is set, layers to be overlaid on the map are selected, and map markers are generated on each of the layers. The map markers are matched with points of interest on the map, and points of interest are generally represented as metadata described by an information representation method defined for applications. However, the MPEG-ARAF fails to define a standard for points of interest.

Methods for representing map instances known as points of interest vary depending on applications, and information structure is not disclosed to protect against illegal editing or theft. However, as points of interest are not represented by a standard notation method, there is a problem in that map instance information, which is continuously updated, is difficult to manage in a single application. Further, different notation methods make it impossible to share map instance information in applications that have similar functions, thereby resulting in inefficient use of information.

Moreover, an augmented realty system is a general system that is widely used by many users who have their own preferred setting information and augmented reality information. However, even a metadata structure is not defined that includes user preference information for providing a customized augmented reality navigation system, such that users are required to set an augmented reality system according to their preferences every time they operate their own system.

### SUMMARY

Disclosed is an apparatus and method for processing metadata that displays customized information when providing an augmented reality navigation system.

In the apparatus and method for processing metadata, map-related metadata and user preference metadata are defined to provide customized information based on the definition.

In the apparatus and method for processing metadata, categories of augmented reality information frequently searched by a user may be provided.

In the apparatus and method for processing metadata, augmented reality services customized for users may be provided by loading map point information, which is stored as metadata in a map-based augmented reality navigation system implemented based on MPEG-4 BIFS, to display a map point on a virtual map, and by loading user preference information stored as metadata.

Further, according to an exemplary embodiment of the present disclosure, an augmented reality navigation device and method may be provided, which has a more simplified and standardized structure, by using map information metadata based on MPEG-4 BIFS and user preference information metadata.

Disclosed is an apparatus for processing metadata, the apparatus including: a map node defining component configured to define a map node for setting a virtual map; a map overlay node defining component configured to define a map overlay node for setting a layer in which an augmented reality object is to be overlaid on a map set according to the map node defined by the map node defining component; a map marker node defining component configured to define a map marker node for setting a position of the augmented reality object on the map, which is to be overlaid on the layer set according to the map overlay node defined by the map overlay node defining component; a point of interest node defining component configured to set information on a point of interest, which is a position of the augmented reality object on the map; and a controller configured to load the virtual map according to the map node defined by the map node defining component, load the layer according to the map overlay node defined by the map overlay node defining component, load the map marker according to the map marker node defined by the map marker node defining component, and load the point of interest according to the point of interest node defined by the point of interest node defining component.

The point of interest node defining component defines the point of interest node for setting information on the point of interest, which includes one or more of the following: whether a point of interest node is activated, a 3D vector value that represents a location of the point of interest, a radius of detection, a category of the point of interest, a name of the point of interest, a phone number of the point of interest, an email address of the point of interest, a list of providers of one or more of the point of interest, a registered time of the point of interest, a number of web resources that provide all types of information associated with the point of interest, a rating of the point of interest, a total number of ratings of the point of interest, information related to the point of interest, metadata of the point of interest, a number of the point of interest filtered, a set value of error occurrence when the filtering.

The apparatus for processing metadata may further include a map marker metadata storage configured to store, as metadata, information on the position of the augmented reality object on a map, which is to be overlaid; and a user preference information metadata storage configured to receive input of information on a user preference from a user input device and to store the received information as metadata, wherein the controller may generate a map marker by using the map marker metadata stored in the map marker metadata storage and using the user preference information metadata stored in the user preference information metadata storage, and to load the generated map marker.

The map marker metadata may include one or more of the following: information that indicates a name of the map marker, information on latitude, longitude, and altitude of the map marker, an email addresses of the position of the map marker, details of the map marker, providers of the map marker metadata, production dates of the map marker metadata, resources to represent the map marker as media, and information indicative of containers to include standards related to conventional points of interest.

The user preference metadata may include one or more of the following: information that indicates a radius within which an augmented reality object is to be displayed with the user on its center, information on a category of the point of interest desired by the user, information on a mode preferred by the user for representing the map, information on a media type of the augmented reality object desired by the user, information on a maximum number of the augmented reality object to be displayed on a screen of the user, and information on a zoom level of the map selected by the user.

The map node may include a user preference information field. The map node may set one or more of the zoom level of the map and the mode of the map by reference to the stored user preference information metadata in the user preference information field.

The map overlay node may include one or more of the user preference information field and the point of interest metadata field. The map overlay node may set one or more of attributions of visibility and clickability of the map marker by reference to the stored user preference information metadata in the user preference information field. The map overlay node may set the map marker by reference to the stored map marker metadata in the point of interest metadata field.

The map marker node may include one or more of a map marker update field and an updateVisible field. The map marker node may update the map marker by reference to the stored map marker metadata in the map marker update field. The map marker node may set a visibility attribution of the map marker by reference to the stored user preference information metadata in the updateVisible field.

Disclosed is a method for processing metadata, the method including: defining a map node for setting a virtual map; defining a map overlay node for setting a layer in which an augmented reality object is to be overlaid on a map set according to the defined map node; defining a map marker node for setting a position of the augmented reality object on the map, which is to be overlaid on the layer set according to the defined map overlay node; defining a point of interest node for setting information on a point of interest, which is a position of the augmented reality object on the map; and loading the virtual map according to the defined map node, loading the layer according to the defined map overlay node, loading the map marker according to the defined map marker node, and loading the point of interest according to the defined point of interest node.

The method for processing metadata may further include: storing, as metadata, information on the position of the augmented reality object on a map, which is to be overlaid; receiving input of information on a user preference from a user input device, and storing the received information as metadata; and generating a map marker by using the stored map marker metadata and the stored user preference information metadata, and loading the generated map marker.

The map node may include a user preference information field and sets one or more of a zoom level of the map and a mode of the map by reference to the stored user preference information metadata in the user preference information field.

The map overlay node may include the user preference information field, and sets one or more of attributions of visibility and clickability of the map marker by reference to the stored user preference information metadata in the user preference information field.

The map overlay node may include the point of interest metadata field, and sets the map marker by reference to the stored map marker metadata in the point of interest metadata field.

The map marker node may include a map marker update field, and updates the map marker by reference to the stored map marker metadata in the map marker update field.

The map marker node may include an updateVisible field, and sets a visibility attribution of the map marker by reference to the stored user preference information metadata in the updateVisible field.

### BRIEF DESCRIPTION OF THE DRAWINGS

FIG. 1 is a block diagram schematically illustrating an example of a conventional navigation device.

FIG. 2 is a block diagram illustrating an example of a system for providing a map-based augmented reality navigation service according to an exemplary embodiment.

FIG. 3 is a block diagram illustrating an example of a system for providing a map-based augmented reality navigation service according to another exemplary embodiment.

FIG. 4 is a block diagram schematically illustrating an example of a metadata processor according to an exemplary embodiment.

FIG. 5 is a diagram illustrating an XSD description of a map node.

FIG. 6 is a diagram illustrating a MPEG-4 BIFS textual description of a map node.

FIG. 7 is a diagram illustrating an XSD description of a map overlay node.

FIG. 8 is a diagram illustrating a MPEG-4 BIFS textual description of a map overlay node.

FIG. 9 is a diagram illustrating an XSD description of a map marker node.

FIG. 10 is a diagram illustrating a MPEG-4 BIFS textual description of a map marker node.

FIG. 11 is a diagram illustrating an XSD description of a point of interest node.

FIG. 12 is a diagram illustrating a MPEG-4 BIFS textual description of a point of interest node.

FIG. 13 is a diagram illustrating a correlation among a map node, a map overlay node, and a map marker node, which are defined for providing a map-based augmented reality service to the MPEG-ARAF.

FIG. 14 is a diagram illustrating an example of generating a map point instance, or updating the generated map point instance when setting an initial map using map marker metadata defined according to an exemplary embodiment.

FIG. 15 is a flowchart illustrating an example of a method for processing metadata according to an exemplary embodiment.

FIG. 16 is a flowchart illustrating an example of a method for processing metadata according to another exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

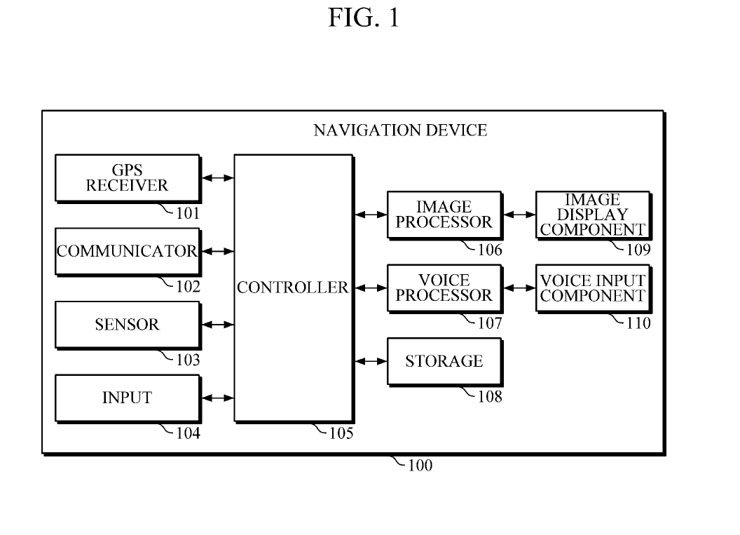

FIG. 1 is a block diagram schematically illustrating an example of a conventional navigation device.

Referring to FIG. 1, the navigation device 100 includes a global positioning system (GPS) receiver 101, a communicator 102, a sensor 103, an input 104, a controller 105, an image processor 106, a voice processor 107, a storage 108, an image display component 109, and a voice output component 110.

The navigation device 100 may be implemented by various methods. For example, the navigation device 100 may be installed in a vehicle navigation device, a portable personal navigation device (PND), a mobile communication terminal, such as a smartphone and the like, a personal digital assistant (PDA), and the like.

Further, the navigation device 100 in FIG. 1 is an illustrative example, and may include only some parts of the modules illustrated in FIG. 1, and/or may further include other modules necessary for its operations. For example, the navigation device 100, such as a user interface and the like, may include common additional elements. Alternatively, the navigation device 100 may further include a power supply that supplies battery power to a power manager according to control of the controller 105, and a power manager that selectively provides DC power, battery power, or the like to the navigation device 100.

The global positioning system (GPS) receiver 101 uses satellite signals received from various artificial satellites through antennas to calculate location values of a navigation device, and transmits the calculated location values to the controller 105.

The communicator 102 transmits or receives information to or from other devices through various wired or wireless communication modules according to control signals from the controller 105.

The sensor 103 detects rotation angles and speeds of a navigation device or a vehicle with a navigation device, and transmits detected values to the controller 105. For example, the sensor 103 may include a gyro sensor, a speed sensor, or the like.

The input 104 generates various manipulation signals to control operations of the navigation device 100. Specifically, once a key is input through the input 104 to request a navigation service, a manipulation signal to request a navigation service is generated and transmitted to the controller 105. Then, input manipulation signal, such as a destination input or the like, a manipulation signal to request real image information, a pointer selection manipulation signal, and the like are generated and transmitted to the controller 105. For example, the input 104 may be operated by using a keypad, a touch screen, and the like.

The controller 105 controls overall operations of the navigation device 100. Specifically, the controller 105 may perform mapping of location values of the navigation device that are transmitted from the GPS receiver 101, i.e., GPS signals, with map data stored in the storage 108 according to various manipulation signals transmitted from the input 104, and mapping of values that include rotation angles, speed, and the like, of the navigation device transmitted from the sensor 103 with map data. The controller 105 may transmit the mapped driving path data to the image processor 106 to display the data on a screen, and may transmit control signals to the voice processor 107 to output various alarm signals, voice guidance signals and the like through the output 110

Further, once a destination is input in response to a request of a navigation service, the controller 105 detects a driving path to the destination, and once a manipulation signal to request real image information is received from the input 104, the controller 105 is connected to a geographic information system (GIS), and the like, through the communicator 102 to transmit detected driving path data, and transmits control signals to the image processor 106 so that the received real image information received through the communicator 102 may be displayed on the detected driving path. Once a pointer selection manipulation signal is received from the input 104 to re-detect a driving path, the controller 105 re-detects a driving path, in which pointer information is mapped with information data, and transmits control signals to the image processor 106 to display the re-detected driving path. The real image information may include GIS-related information, pointer information, and the like.

The image processor 106 processes digital signals for image signals. Specifically, once driving path data that displays driving paths is transmitted from the controller 105, the image processor 106 processes the data into image signals to display the image signals through the image display component 109 that includes a liquid crystal display (LCD) and the like. For example, the image processor 106 may process digital signals for image signals, including an MPEG codec, and the like.

The voice processor 107 may process digital signals for voice signals. Specifically, once voice guidance data is transmitted from the controller 105 during a navigation service at a time when voice guidance is needed, the voice processor 107 may process the voice guidance data into voice signals and output the voice signals through the voice output component 110. For example, the voice processor 107 may process digital signals for voice signals, including an MPEG codec, and the like.

The storage 108 stores various types of map information to provide a path detection and navigation service, various types of voice guidance information to provide a voice guidance service, information on image display levels, and the like. Further, the storage 108 may extract information stored in the storage 108 if necessary, and transmit the extracted information to the controller 105. For example, the storage 108 may be a storage medium that includes a memory, a hard disk drive (HDD), and the like.

The image display component 109 outputs images. For example, the image display component 109 may be a liquid crystal display (LCD) and the like.

The voice output component 110 outputs voice or audio signals. For example, the voice output component 110 may be a speaker and the like.

The augmented reality service is provided in such a manner that additional information is overlapped on an image captured by a camera installed in a mobile device. For example, while walking on a street, once a user operates a camera of a mobile device to receive location information of a destination, and executes an augmented reality application, a location and a direction of the user is identified using a GPS sensor, a compass sensor, a gyro sensor, and the like of a mobile device, and displays a direction of a destination on the image captured by a camera.

The augmented reality system is a general system used by many users who have their own preferred setting information and augmented reality information. Accordingly, it is convenient for users to store and load their preferred information as metadata so that they may use the stored data as they need, instead of setting the augmented navigation system according to their preferences every time the system is operated. For example, after storing signal information once, such as a zoom level preferred by a user, or location categories frequently searched for by a user, the stored information is required to be loaded automatically and set every time an augmented reality navigation system is operated, which will be described in detail with reference to the drawings below.

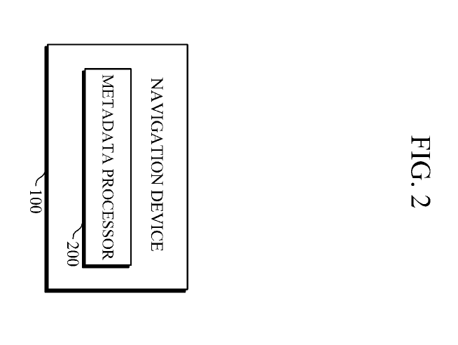

FIG. 2 is a block diagram illustrating an example of a system for providing a map-based augmented reality navigation service according to an exemplary embodiment.

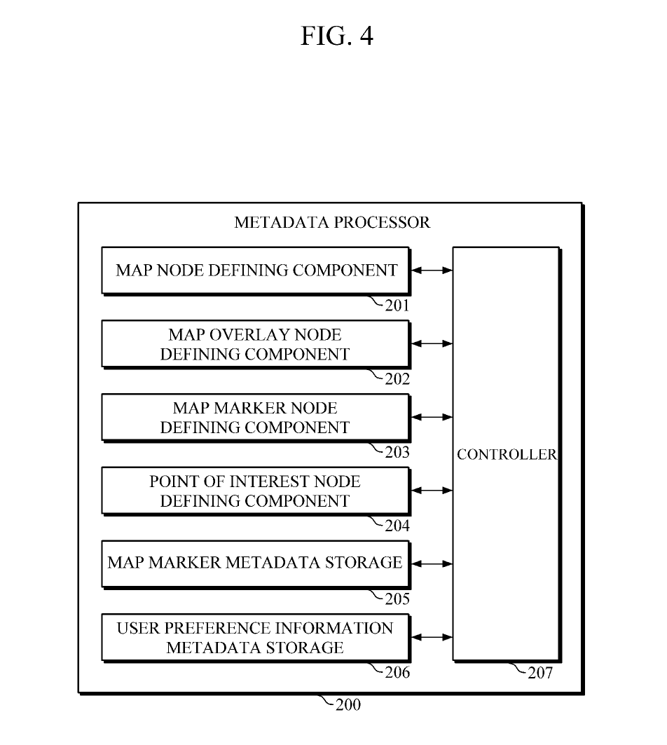

Referring to FIG. 2, the system for providing a map-based augmented reality navigation service may further include a metadata processor 200 in the navigation device 100. The metadata processor 200 may transmit and receive data to and from modules included in the navigation device 100 illustrated in FIG. 1. For example, the metadata processor 200 may provide resulting values of metadata processing to the controller 105 of the navigation device 100. The metadata processor 200 will be described in detail with reference to FIG. 4 later.

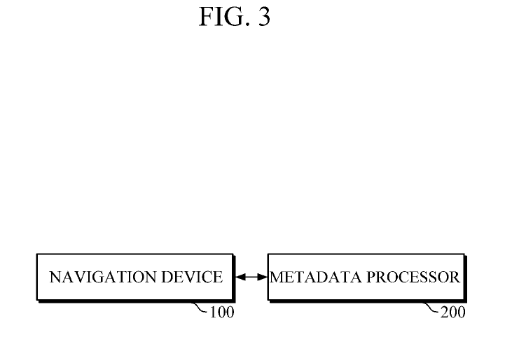

FIG. 3 is a block diagram illustrating an example of a system for providing a map-based augmented reality navigation service according to another exemplary embodiment.

Referring to FIG. 3, the system for providing a map-based augmented reality navigation service includes a navigation device 100, a metadata processor 200, and the like.

Further, the system for providing a navigation service in FIG. 3 is merely an illustrative example, and the system may further include other necessary devices for its operations. For example, a separate wired or wireless communication network may be provided for information exchange between the navigation device 100 and the metadata processor 200, and a communication device, and the like, may be further provided for communications between the navigation device 100 and the metadata processor 200. The metadata processor 200 will be described in detail with reference to FIG. 4 below.

FIG. 4 is a block diagram schematically illustrating an example of a metadata processor according to an exemplary embodiment.

Referring to FIG. 4, the metadata processor 200 includes a map node defining component 201, a map overlay node defining component 202, a map marker node defining component 203, a point of interest node defining component 204, and a controller 207. In an exemplary embodiment, the metadata processor 200 may further include a map marker metadata storage 205 and a user preference information storage 206.

Further, the metadata processor 200 in FIG. 4 is merely an illustrative example, and may include only some parts of the modules illustrated in FIG. 4, and/or may further include other modules necessary for its operations. For example, the metadata processor 200 may further include a communicator for communications with other devices, and the like.

Map-related nodes defined in a conventional MPEG-ARAF are map nodes, map overlay nodes, and map marker nodes, which set layers for grouping map instances, and define map instances. However, in the conventional method, map instances are not defined by reference to metadata of previously defined map instances, and an initial setting of an augmented reality app or customized augmented reality information are not provided. Methods for representing map instances known as points of interest vary depending on applications, and information structure is not disclosed to protect against illegal editing or theft. However, as points of interest are not represented by a standard notation method, there is a problem in that map instance information, which is continuously updated, is difficult to be managed in a single application. Further, different notation methods make it impossible to share map instance information in applications that have similar functions, thereby resulting in inefficient use of information.

Accordingly, in the present disclosure, points of interest nodes, map marker metadata, and user preference metadata are defined, and the metadata may be used by modifying map-related nodes of MPEG-ARAF, which will be described in detail below.

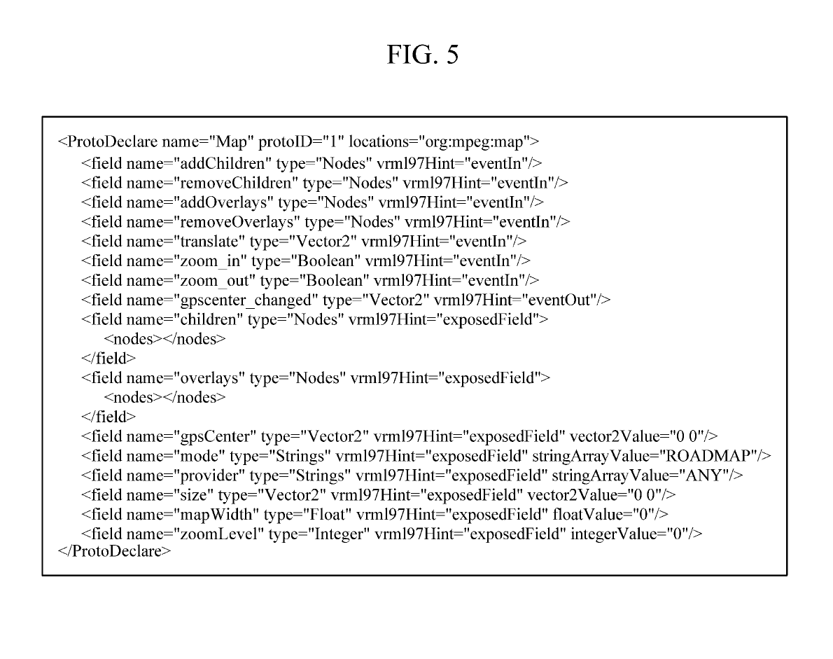

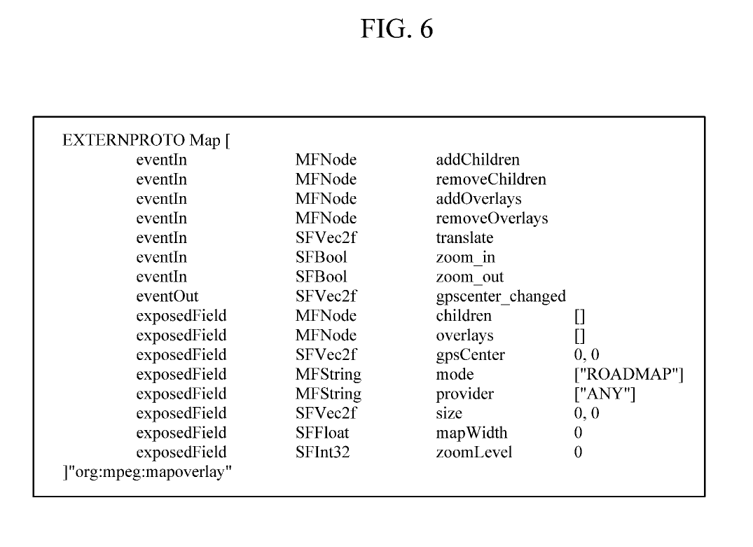

The map node defining component 201 defines a map node for setting a virtual map. FIG. 5 is a diagram illustrating an XSD description of a map node. FIG. 6 is a diagram illustrating a MPEG-4 BIFS textual description of a map node.

Referring to FIGS. 5 and 6, definition of a map node based on MPEG-4 BIFS will be described. A map node prototype provides a map that may be displayed on a screen. The map node detects dragging of a pointer device, and enables dragging of map images. The dragging changes gpsCenter corresponding to the dragging, and executes a new GPS center value and a center-changed event.

The “addChildren” specifies a list of map marker nodes to be added to a children field of a map.

The “removeChildren” specifies a list of map marker nodes to be removed from a children field of a map.

The “addOverlays” specifies a list of map overlay nodes to be added to an overlay field of a map.

The “removeOverlays” specifies a list of map overlay nodes to be removed from an overlay field of a map.

The “translate” specifies a translation that is to be applied to an image of a map. The values are represented in the local coordinate system of map nodes, and a gpsCenter is modified.

The “zoom_in” specifies a case where a zoom level region is increased by one.

The “zoom_out” specifies a case where a zoom level region is decreased by one.

The “gpscenter_changed” is executed when gpsCenter of map nodes is changed by dragging, conversion event, or directly changing field values.

The “children” specifies a list of map marker nodes to be drawn on a specific map. The drawn map is fixed at a boundary of map nodes, and a size of children is not dependent on a zoom level.

The “overlays” specifies a list of map overlay nodes to be drawn on a specific map. The drawn children are fixed at a boundary of map nodes, and a size of children is not dependent on a zoom level.

The “gpsCenter” represents a center of a drawn map that corresponds to a center of map nodes, in which an x value refers to the longitude, and a y value refers to the latitude.

The “mode” specifies types of maps. Possible values are “SATELLITE”, “PLANE”, “ROADMAP”, AND “TERRAIN”. The “SATELLITE” mode is generally required to display map images captured from a vertical perspective by a satellite. The “PLANE” mode is generally required to display map images captured nearly at an angle of 45° by an airplane. The “ROADMAP” is generally required to display vector drawing images of roads, buildings, and other similar characteristics. The “TERRAIN” mode is required to display map images that are physically clear to show terrain and plants.

If multiple values are specified in the map field, then the resulting image should be a combination of all desired modes as long as they are supported by the map provider. If a certain combination is not supported, then the map view falls back to the closest supported one.

The “provider” specifies map providers desired to be used. The provider field is a multi-value field that may represent a designer as a substitute for a map provider, in which by selecting “ANY”, a client may select a provider.

The “size” indicates a size of a map viewport. The viewport refers to a region set to display a graphic image on a part of a display device as an image display region on a display screen.

The “mapWidth” indicates the length in meters on the longitude axis of a desired visible map, includes a map desired by a client and calculates a maximum zoom level to set values in a zoomLevel field. If the mapWidth is set as 0, a zoomLevel field value is used.

The “zoomLevel” indicates a resolution of a current view. While a minimum value of a zoom level is 1, its maximum value is defined according to its functions by a map provider. A zoom level of 0 includes the entire globe, and subsequent zoom levels have precision twice greater than zoom level 0 in both horizontal and vertical terms.

The map overlay node defining component 202 defines layers, in which augmented reality objects are to be overlaid on a map set according to map nodes defined by the map node defining component 201.

The map overlay node may add a plurality of map marker nodes as child nodes. Through the map overlay node, child nodes, i.e., map marker nodes as lower nodes may be generally controlled. For example, map marker nodes, which are lower nodes, may be controlled not to be seen at the same time, or a click event for these map marker nodes may be permitted at the same time.

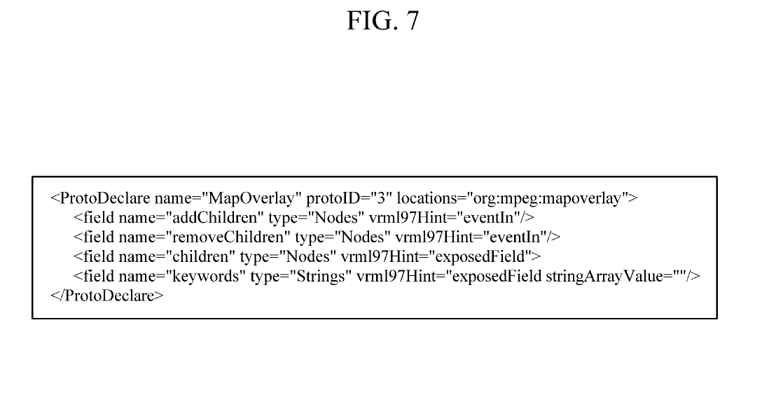

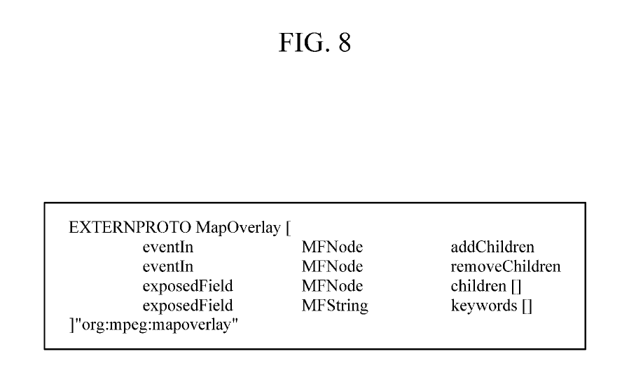

FIG. 7 is a diagram illustrating an XSD description of a map overlay node. FIG. 8 is a diagram illustrating a MPEG-4 BIFS textual description of a map overlay node.

Referring to FIGS. 7 and 8, map overlay nodes based on MPEG-4 BIFS will be described. A prototype of map overlay nodes provides layers that may be displayed on a screen.

The “addChildren” specifies a list of map marker nodes to be added to a children field of a map overlay.

The “removeChildren” specifies a list of map marker nodes to be removed from a children field of a map overlay.

The “children” specifies a list of map marker nodes.

The “keywords” specifies a semantic description of a specific map overlay node, such as a “restaurant”, a “museum”, and the like.

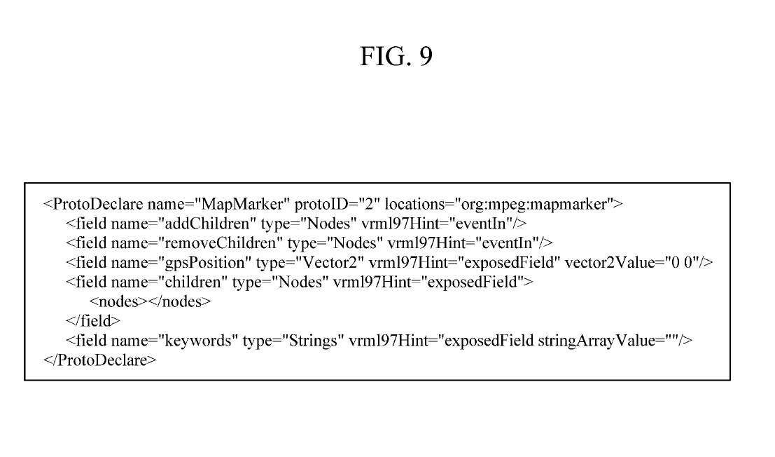

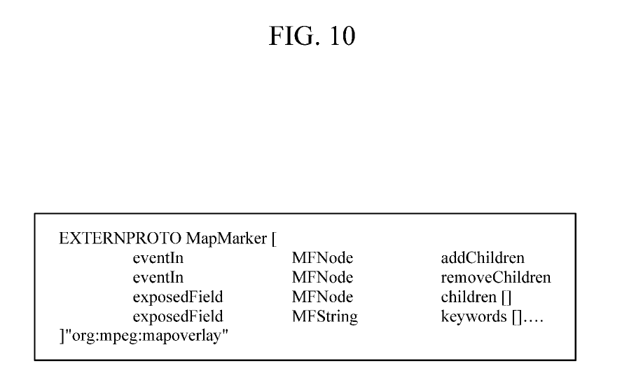

The map marker node defining component 203 defines map marker nodes for setting points of interest of an augmented reality object to be overlaid on a layer set according to a map overlay node defined by the map overlay node defining component 202. FIG. 9 is a diagram illustrating an XSD description of a map marker node. FIG. 10 is a diagram illustrating a MPEG-4 BIFS textual description of a map marker node.

Referring to FIGS. 9 and 10, map marker nodes based on MPEG-4 BIFS will be described. A prototype of map marker nodes provides points of interest, i.e., information on instances, which may be displayed on a screen.

The “addChildren” specifies a list of 2-dimensional (2D) nodes to be added to a children field of a map marker.

The “removeChildren” specifies a list of 2D nodes to be removed from a children field of a map marker.

The “gpsPosition” specifies a specific GPS location in a map node.

The “children” specifies a list of 2D nodes to be drawn.

The “keywords” specifies a semantic description of a specific map overlay node, such as a “restaurant”, a “museum”, and the like.

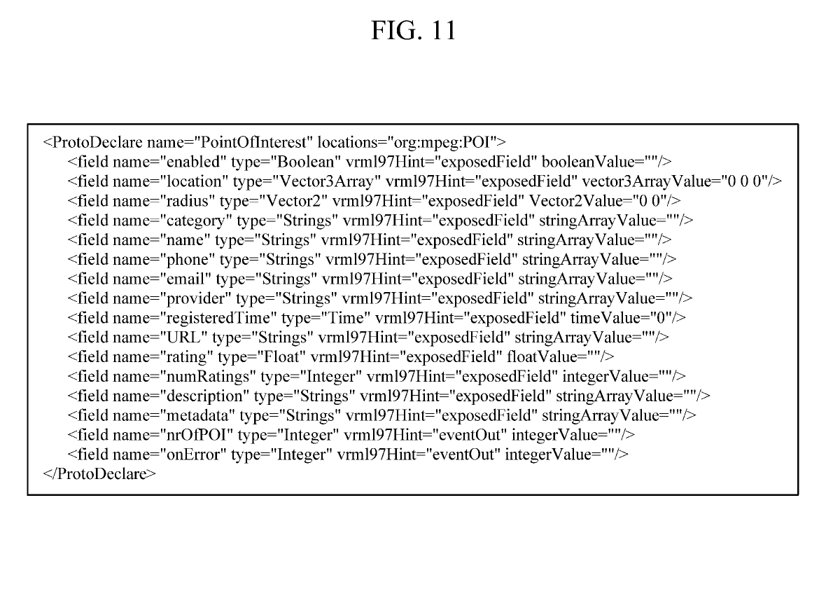

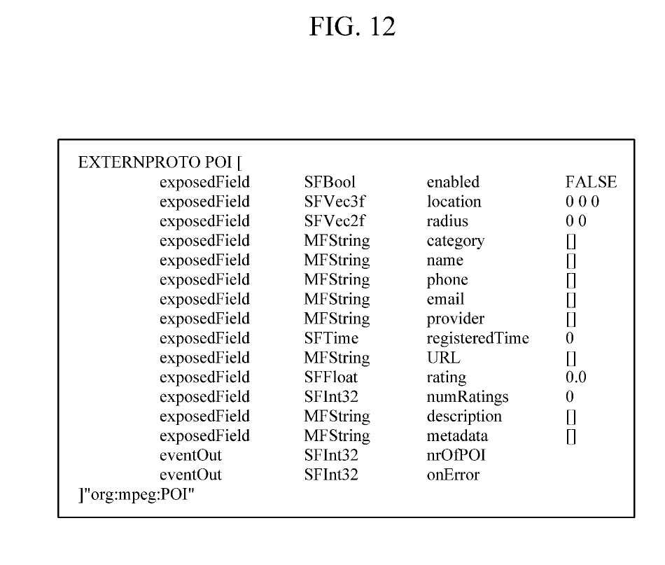

The point of interest node defining component 204 defines points of interest for setting information on points of interest that are points on a map of an augmented reality object. FIG. 11 is a diagram illustrating an XSD description of a point of interest node. FIG. 12 is a diagram illustrating a MPEG-4 BIFS textual description of a point of interest node.

Referring to FIGS. 11 and 12, points of interest nodes based on MPEG-4 BIFS will be described. A prototype of points of interest nodes provides metadata associated with a specific geographic location or an event.

The “enabled” specifies whether or not to activate a point of interest node.

The “location” is a 3-dimensional (3D) vector value that indicates locations of points of interest, in which a first value represents latitude of a point of interest, a second value represents longitude of a point of interest, and a third value represents altitude of a point of interest.

The “radius” specifies a radius of detection, in which a first value represents a minimum distance between a user and a point of interest, a second value represents a maximum distance between a user and a point of interest. Only in a case where a GPS location of a user is positioned between the minimum value and a maximum value, a point of interest may be displayed as detection results.

The “category” may include one or more predefined keywords that describe points of interest (e.g., restaurant, airport, hotel, etc.) in various manners.

The “name” specifies names of points of interest.

The “phone” specifies phone numbers of points of interest.

The “email” specifies email addresses of points of interest.

The “provider” specifies a list of providers of one or more points of interest.

The “registeredTime” specifies registered time of points of interest.

The “URL” stores a number of web resources that provide all types of information associated with points of interest. For example, the information may include web pages that describe points of interest, 3D photographs of points of interest, voices, and the like.

The “rating” specifies ranks according to evaluations. Rating values may be floating-point numbers from 0 to 10, in which a good point of interest may be rated 10, and a bad point of interest may be rated 0. For example, a good point of interest may be a highly valued restaurant, and a bad point of interest may be a least recommended hotel, which may be rated 0.

The “numRatings” specifies a total number of evaluations of points of interest.

The “description” includes information associated with points of interest.

The “metadata” stores specific metadata of a certain point of interest.

The “nrOfPOI” returns a number of filtered points of interest.

The “onError” is set when an error occurs in a filtering algorithm. Error codes are defined in which 0 represents no error, and 1 represents an undesignated error.

Hereinafter, the map marker metadata storage 205 and the user preference information metadata storage 206 will be described in detail.

The metadata refers to data that is structured to describe other data, and is also called attribution information. The metadata is data that is assigned to content according to specific rules, so that desired information may be retrieved efficiently from among a large amounts of information. The metadata includes locations and details of content, information on a creator, conditions and rights, conditions of usage, usage history, and the like. In a computer, metadata is generally used for representing and rapidly retrieving data.

An HTML tag is a good example of using metadata for representing data. Structuralization of data indicates that data is structured in a form of a tree from top to bottom, in which a head and a body is included in an HTML tag, a table is included in the body, tr is in the table, and td is in the tr.

Metadata used for rapidly retrieving data acts as an index of information in a computer. Data may be retrieved rapidly from a database with well-established metadata. A user may retrieve desired data by using metadata with a search engine or the like. For example, data on actors in a scene of a movie may be extracted, or a scene of scoring a goal in a football match may be extracted. Further, these types of data may be edited by using metadata.

In both of the above cases of using metadata, metadata is not seen to a user that uses data, while a machine (computer) understands and uses details of metadata. That is, metadata is information that can be understood by a machine regarding web documents or others. In other words, map marker metadata defines schema for representing map marker information in a standardized manner, and user preference information metadata defines schema for representing user preference information in a standardized manner.

The map marker metadata storage 205 stores information on map points as metadata.

Table 1 is a structure of map marker metadata of the present disclosure.

```
  <schema xmlns=“http://www.w3.org/2001/XMLSchema”
xmlns:mpeg7=“urn:mpeg:mpeg7:schema:2004” xmlns:arafmm=“urn:org:mpeg-araf:2013:10-
mapmarker” targetNamespace=“urn:org:mpeg:arafpoi:2013:10-mapmarker”
elementFormDefault=“qualified” attributeFormDefault=“unqualified” version,“ISO/IEC
23000-13” >
  <import namespace=“urn:mpeg:mpeg7:schema:2004”
schemaLocation=“http://standards.iso.org/ittf/PubliclyAvailableStandards/MPEG-
7_schema_files/mpeg7-v2.xsd” />
  <complexType name=“MapmarkerBaseType” abstract=“true”>
    <complexContent>
      <restriction base=“anyType”>
        <attribute name=“id” type=“ID” use=“optional” />
      </restriction>
    </complexContent>
  </complexType>
  <element name=“Mapmarker” type=“arafmm:MapmarkerType” abstract=“true” />
  <complexType name=“MapmarkerType” abstract=“true”>
    <complexContent>
      <extension base=“arafmm: MapmarkerBaseType”>
        <sequence>
          <element name=“Name” type=“string” minOccurs=“1” />
          <element name=“Position” type=“vector3” minOccurs=“1” />
          <element name=“Category” type=“string” minOccurs=“0” />
          <element name=“Address” type=“string” minOccurs=“0” />
          <element name=“Url” type=“string” minOccurs=“0” />
          <element name=“Phone” type=“string” minOccurs=“0” />
          <element name=“Email” type=“string” minOccurs=“0” />
          <element name=“Description” type=“string” minOccurs=“0” />
          <element name=“Provider” type=“string” minOccurs=“0” />
          <element name=“Time” type=“time” minOccurs=“0” />
          <element name=“Resources” type=“arafmm:ResourceType” minOccurs=“0”
/>
          <element name=“Metadata” type=“arafmm:MetadataType” minOccurs=“0”
/>
        </sequence>
      </extension>
    </complexContent>
  </complexType>
  <complexType name=“ResourceType”>
    <choice>
      <element name=“Inline” type=“mpeg7:InlineMediaType” minOccurs=“0” />
      <element name=“Remote” type=“anyURI” minOccurs=“0” />
    </choice>
  </complexType>
  <complexType name=“MetadataType” final=“#all”>
    <sequence>
      <any namespace=“##any” processContents=“lax” minOccurs=“0”
maxOccurs=“unbounded”/>
    </sequence>
  </complexType>
  </schema>
```

Here, a “name” element specifies names of map markers.

A “position” element specifies latitude, longitude, and altitude of map markers.

An “email” element, which is a contact point for a map marker point, indicates email addresses.

A “description” element specifies explanation of map markers.

A “provider” element specifies providers of map marker metadata.

A “time” element specifies production dates of map marker metadata.

A “resource” element specifies resources for representing map markers as media. Examples thereof include images, video, sphere, a complex 3D graphics, and the like. Further, the resource element may include a resource itself, or may indicate a place where a resources is located.

A “metadata” element specifies containers to include conventional standards, such as KML and GPX, which are related to points of interest (POI).

The user preference information metadata storage 206 receives input of user preference information from a user input device and stores the received information as metadata.

Table 2 is a structure of a user preference metadata of the present disclosure.

```
  <schema xmlns=“http://www.w3.org/2001/XMLSchema”
xmlns:mpeg7=“urn:mpeg:mpeg7:schema:2004” xmlns:arafup=“urn:org:mpeg-araf:2013:10-
userpreference” targetNamespace=“urn:org:mpeg:arafpoi:2013:10-userpreference”
elementFormDefault=“qualified” attributeFormDefault=“unqualified” version,“ISO/IEC
23000-13” >
  <complexType name=“UserBaseType” abstract=“true”>
    <complexContent>
      <restriction base=“anyType”>
        <attribute name=“id” type=“ID” use=“optional” />
      </restriction>
    </complexContent>
  </complexType>
  <element name=“ARPreference” type=“arafup:ARPreferenceType” abstract=“true” />
  <complexType name=“ARPreferenceType” abstract=“true”>
    <complexContent>
      <extension base=“arafup:UserBaseType”>
        <sequence>
          <element name=“Radius” type=“unsignedInt” minOccurs=“0” />
          <element name=“Category” type=“arafup:CategoryType” minOccurs=“0” />
          <element name=“MapMode” type=“arafup:MapModeType” minOccurs=“0”
/>
          <element name=“ZoomLevel” type=“unsignedInt” minOccurs=“0” />
          <element name=“ARMediaType” type=“string” minOccurs=“0” />
          <element name=“NumItem” type=“unsignedInt” minOccurs=“0” />
        </sequence>
      </extension>
    </complexContent>
  </complexType>
  <complexType name=“CategoryType”>
    <attribute name=“Automotive” type=“mpeg7:termReferenceType” use=“optional”
/>
    <attribute name=“Business” type=“mpeg7:termReferenceType” use=“optional” />
    <attribute name=“Education” type=“mpeg7:termReferenceType” use=“optional” />
    <attribute name=“Emergency” type=“mpeg7:termReferenceType” use=“optional” />
    <attribute name=“Entertainment” type=“mpeg7:termReferenceType”
use=“optional”/>
    <attribute name=“FoodDrink” type=“mpeg7:termReferenceType” use=“optional” />
    <attribute name=“Government” type=“mpeg7:termReferenceType” use=“optional”
/>
    <attribute name=“PublicServices” type=“mpeg7:termReferenceType”
use=“optional” />
    <attribute name=“Recreation” type=“mpeg7:termReferenceType” use=“optional” />
    <attribute name=“Shops” type=mpeg7:termReferenceType” use=“optional” />
    <attribute name=“TouristAttraction” type=“mpeg7:termReferenceType”
use=“optional” />
    <attribute name=“Traffic” type=“mpeg7:termReferenceType” use=“optional” />
    <attribute name=“Transportation” type=“mpeg7:termReferenceType”
use=“optional”/>
  </complexType>
  <simpleType name=“MapModeType”>
    <restriction base=“string”>
      <enumeration value=“SATELLITE”/>
      <enumeration value=“PLANE”/>
      <enumeration value=“ROADMAP”/>
      <enumeration value=“TERRAIN”/>
    </restriction>
  </simpleType>
  </schema>
```

A “radius” element specifies a radius (meter) within which an augmented reality object is represented with a user at a center.

A “category” element specifies categories of POI a user wishes to search for. Examples thereof include a restaurant, a parking lot, a shopping center, a theme park, and the like. The category element is represented by a termReferenceType defined by ISO/IEC 15938-5.

A “mapmode” element specifies a mode preferred by a user for representing a map. A user may select one from among “SATELLITE”, “PLANE”, “ROADMAP”, and “TERRAIN”.

An “ARMediaType” element specifies media types of augmented reality objects that a user wishes to view, and examples thereof include an image, a text, and the like.

A “NumItem” element specifies a maximum number of augmented reality objects to be displayed in a user's window.

A “ZoomLevel” element specifies zoom levels of a map selected by a user, in which a minimum value of a zoom level is 0, and a maximum value of a zoom level is 100.

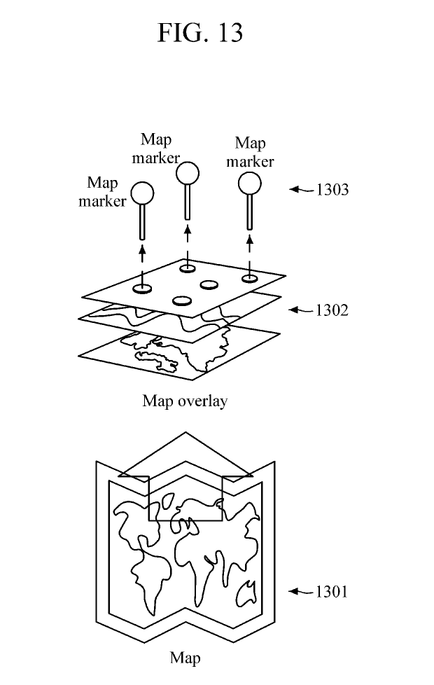

FIG. 13 is a diagram illustrating a correlation among a map node, a map overlay node, and a map marker node, which are defined for providing a map-based augmented reality service to the MPEG-ARAF.

Referring to FIGS. 4 and 13, a virtual map 1301 is set according to a map node defined by the map node defining component. Once the map 1301 is set according to the map node, a layer 1302 is set, in which an augmented reality object is to be overlaid on a map according to a map overlay node defined by the map overlay node defining component. Once the layer 1302 is set according to the map overlay node, a map marker 1303 is set, which is to be overlaid on the layer 1302 according to the map marker node defined by the map marker defining component.

A plurality of map marker nodes may be added as child nodes to the map overlay node. Through the map overlay node, childe nodes, i.e., map marker nodes as lower nodes may be generally controlled. For example, map marker nodes, which are lower nodes, may be controlled not to be seen at the same time, or a click event for these map marker nodes may be permitted at the same time. Further, the map marker nodes may basically include coordinate information and names of points, which are nodes indicative of points on a map.

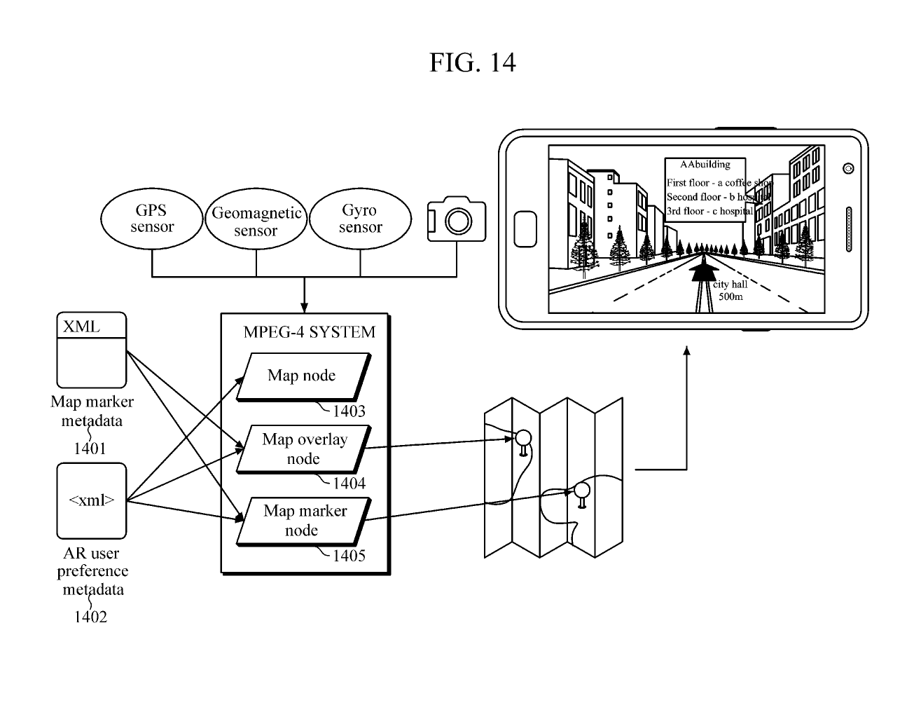

FIG. 14 is a diagram illustrating an example of generating a map point instance, or updating the generated map point instance when setting an initial map using map marker metadata defined according to an exemplary embodiment.

Referring to FIG. 14, a map overlay node 1404 and a map marker node 1405 may be controlled by using map marker metadata 1401. A map node 1403, a map overlay node 1404, and a map marker node 1405 may be controlled by using user preference information metadata 1402. Further, an attribution of visibility of a map marker instance may be ON or OFF by using the user preference information metadata 1402. The map overlay node 1404 may generate an initial map marker by using the map marker metadata 1401, and attributions of visibility or clickability of all the map markers included in a map overlay may be ON or OFF by using the user preference information metadata 1402. In the map node 1403, a zoom level of a map or a map mode (e.g., “SATELLITE”, “PLANE”, “ROADMAP”, “TERRAIN”, etc.) may be set by using the user preference information metadata 1402.

To this end, a structure of the map marker metadata 1401 and a structure of the user preference information metadata 1402 are defined in the present disclosure. Further, a conventional map node, map overlay node, and map marker node are modified to provide a method of using the map marker metadata 1401 and the user preference information metadata 1402 described above. The modified map node, map overlay node, and a map marker node will be described in detail below.

The modified map node has a userPreference field in addition to a conventional map node, and enables a zoom level of a map or a map mode to be set by reference to user preference metadata.

Table 3 is a prototype of a map node of the present disclosure, which is a modified version of a conventional map node.

TABLE 3
EXTERNPROTO Map [

| exposedField | SFString | name | “” |
|---|---|---|---|
| exposedField | SFVec2f | mapTranslation | 0.0 0.0 |
| exposedField | SFVec2f | mapGPSCenter | 0.0 0.0 |
| exposedField | MFNode | overlays | [ ] |
| exposedField | MFString | mode | [“ROADMAP”] |
| exposedField | MFString | provider | [“ANY”] |
| exposedField | SFVec2f | mapSize | 0.0 0.0 |
| exposedField | SFFloat mapWidth | | 0 |
| exposedField | SFInt32zoomLevel | | 0 |
| exposedField | SFString | userPreference | “” |

| | | |
|---|---|---|
| eventIn | MFNode | addOverlays |
| eventIn | MFNode | removeOverlays |
| eventIn | SFVec2f | translate |
| eventIn | SFBool | zoomIn |
| eventIn | SFBool | zoomOut |
| ]“org:mpeg:map” | | |

Further, the modified map overlay node has a userPreference field in addition to a conventional map overlay node, and enables map markers, which are not desired by a user, not to be seen at the same time or to be clickable. Further, a POIMetadata field is added, so that map marker metadata may be referred to when generating map markers.

Table 4 is a prototype of a map overlay node of the present disclosure, which is a modified version of a conventional map overlay node.

TABLE 4
EXTERNPROTO MapOverlay [

| | | | |
|---|---|---|---|
| exposedField | SFString | name | “” |
| exposedField | SFBool | visible | TRUE |
| exposedField | SFBool | enabled | TRUE |
| exposedField | SFBool | clickable | TRUE |
| exposedField | MFNode | children | [ ] |
| exposedField | MFString | keywords | [ ] |
| exposedField | SFString | userPreference | [ ] |
| exposedField | SFString | POIMetadata | [ ] |

| | | |
|---|---|---|
| eventIn | MFNode | addOverlayItems |
| eventIn | MFNode | removeOverlayItems |

]“org:mpeg:mapoverlay”

Further, the modified map marker node has an updateMapmarker field in addition to a conventional map marker node, and enables details of a current map marker to be updated by reference to map marker metadata. Further, an updateVisible field is added, and map markers that are not desired by a user are made unseen by reference to user preference metadata.

Table 5 is a prototype of a map marker node of the present disclosure, which is a modified version of a conventional map marker node.

TABLE 5
EXTERNPROTO MapMarker [

| exposedField | SFString | name | | “” |
|---|---|---|---|---|
| exposedField | SFVec3f | position | 0 0 0 | |
| exposedField | SFRotation | rotation | 0 0 1 0 | |
| exposedField | SFBool | clickable | | TRUE |
| exposedField | SFBool | visible | TRUE | |
| exposedField | SFBool | enabled | TRUE | |

| exposedField | MFNode | markerShape | [ ] |
|---|---|---|---|
| exposedField | MFString | keywords | [ ] |
| eventln | SFBool | doClick | |
| eventln | SFVec2f | setPlayerGPS | |
| eventln | SFVec2f | setMapGPSCenter | |
| eventln | SFInt32setMapZoomLevel | | |
| eventln | SFString | updateMapmarker | [ ] |
| eventln | SFString | updateVisible | [ ] |

| | | |
|---|---|---|
| eventOut | SFBool | onClick |
| eventOut | SFBool | onPlayerAround |
| eventOut | SFBool | onPlayerLeft |

]“org:mpeg:mapmarker”

Referring to FIG. 4, the controller 207: loads a virtual map according to a map node defined by the map node defining component 201; loads a layer according to a map overlay node defined by the map overlay node defining component 202; loads a map marker according to a map marker node defined by the map marker node defining component 203; and loads a point of interest according to a point of interest node defined by the point of interest node defining component 204. In an exemplary embodiment, the controller 207 may generate map markers by using map marker metadata stored in the map marker metadata storage 205, and using user preference information metadata stored in the user preference information metadata storage 206, and may load the generated map markers.

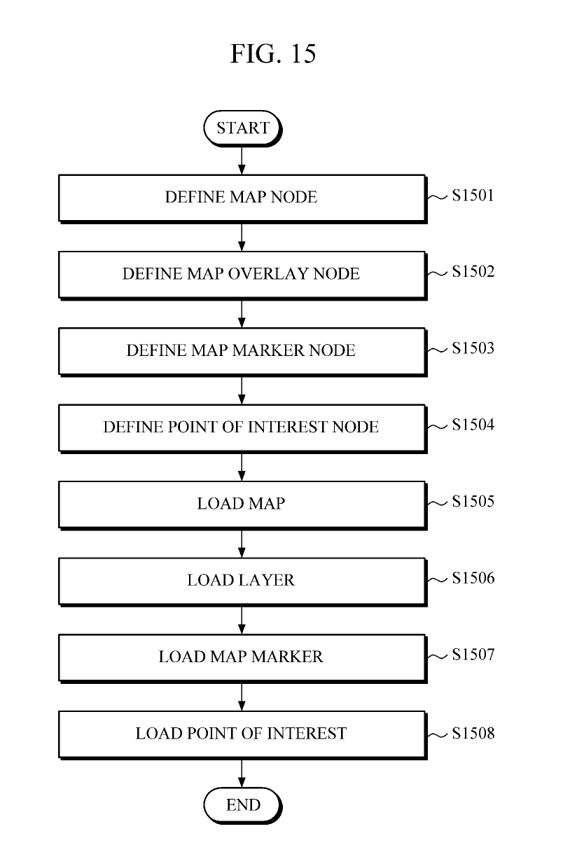

FIG. 15 is a flowchart illustrating an example of a method for processing metadata according to an exemplary embodiment. Operations to be described below, along with exemplary embodiments of the present disclosure, may be implemented in various manners.

The method for processing metadata illustrated in FIG. 15 may be the method for processing metadata illustrated in FIG. 4 by using the metadata processor 200 or an electronic device that includes the metadata processor 200. Accordingly, the method for processing metadata in FIG. 15 will be described briefly to avoid unnecessary repetition, and matters described above with reference to FIG. 4 may be applied to details not described herein.

Referring to FIGS. 4 and 15, a map node for setting a virtual map is defined in S1501.

Subsequently, a map overlay node is defined in S1502. The map overlay node may be a node for setting a layer in which an augmented reality object is to be overlaid on a map set according to a map node defined in S1501.

Then, a map marker node is defined in S1503. The map marker node may be node for setting a position of an augmented reality object on a map that is to be overlaid on a layer set according to a map overlay node defined in S1502.

Next, a point of interest node is defined in S1504. The point of interest node sets information on a point of interest, which is a position of an augmented reality object on a map. The point of interest node may include one or more of the following: whether a point of interest node is activated, a 3D vector value that represents a location of a point of interest, a radius of detection, categories of points of interest, names of points of interest, phone numbers of points of interest, email addresses of points of interest, a list of providers of one or more points of interest, registered time of points of interest, a number of web resources that provide all types of information associated with points of interest, ratings of points of interest, a total number of ratings of points of interest, information related to points of interest, metadata of points of interest, a number of filtered points of interest, a set value of error occurrence when filtering. Points of interest are described in detail above with reference to FIGS. 11 and 12.

Subsequently, a map is loaded according to a defined map node in S1505, a layer is loaded according to a defined map overlay node in S1506, and a map marker is loaded according to a defined map marker node in S1507. Then, a point of interest is loaded according to a defined point of interest node in S1508.

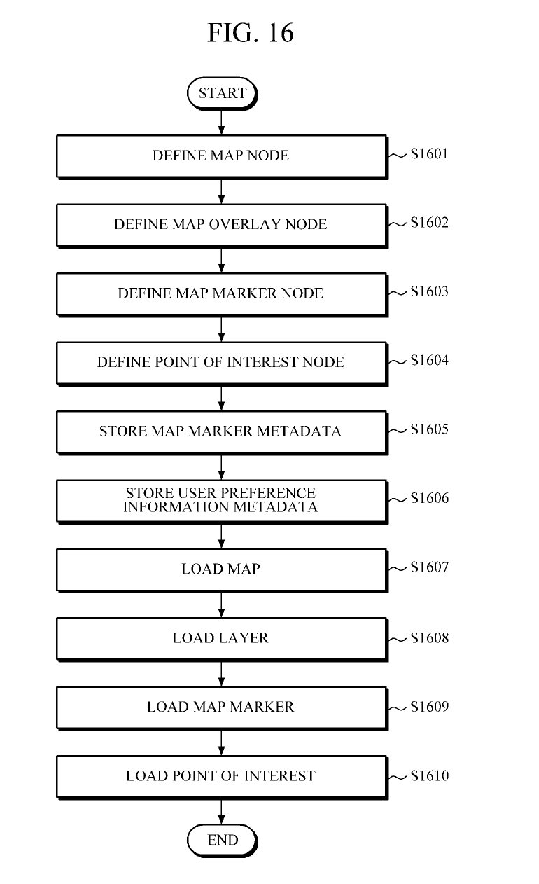

FIG. 16 is a flowchart illustrating an example of a method for processing metadata according to another exemplary embodiment.

Referring to FIGS. 4 and 16, a map node is defined in S1601 to set a virtual map.

Subsequently, a map overlay node is defined in S1602. The map overlay node may be a node for setting a layer in which an augmented reality object is to be overlaid on a map set according to a map node defined in S1601.

Then, a map marker node is defined in S1603. The map marker node may be a node for setting a position of an augmented reality object on a map, which is to be overlaid on a layer set according to a map overlay node defined in S1602.

Next, a point of interest node is defined in S1604. The point of interest node sets information on a point of interest, which is a position of an augmented reality object on a map.

Then, map marker metadata is stored in S1605. Information on a position of an augmented reality object on a map, which is to be overlaid, may be stored as metadata. The map marker metadata may include: information that indicates names of map markers, information on latitude, longitude, and altitude of map markers, email addresses of positions of map markers, details of map markers, providers of map marker metadata, production dates of map marker metadata, resources to represent map markers as media, information indicative of containers to include standards related to conventional points of interest, and the like.

Subsequently, user preference metadata is stored in S1606. User preference information may be input from a user input device to be stored as metadata. The user preference metadata may include information that indicates a radius within which an augmented reality object is to be displayed with a user on its center, information on categories of points of interest desired by a user, information on a mode preferred by a user for representing a map, information on a media type of an augmented reality object desired by a user, information on a maximum number of augmented reality objects to be displayed on a screen of a user, and information on zoom levels of a map selected by a user.

Then, a map is loaded according to a defined map node in S1607. The map node may include a user preference information field. The map node may set one or more of a zoom level of a map and a map mode by reference to user preference information metadata stored in the user preference information field.

Next, a layer is loaded according to a defined map overlay node in S1608. The map overlay node may include a user preference information field. The map overlay node may set one or more attributions of visibility and clickability by reference to user preference information metadata stored in the user preference information field. Further, the map overlay node may include a point of interest metadata field. The map overlay node may set map markers by reference to map marker metadata stored in the point of interest metadata field.

Subsequently, a map marker is generated using stored map marker metadata and stored user preference information metadata, and the generated map marker is loaded in S1609.

The map marker node may include a map marker update field. The map marker node may update map markers by reference to map marker metadata stored in the map marker update field. Alternatively, the map marker node may set a visibility attribution of a map marker by reference to user preference information metadata stored in a visibility attribution update field.

Then, a point of interest is loaded according to a defined point of interest node in S1610.

The present disclosure may be applied to various industrial fields related to broadcast programs, such as broadcast industry, advertising industry, content industry, and the like.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The program commands of the medium may be designed or configured specially for the present invention, or may be used well-known to those who are skilled in the art. Examples of the computer readable recording medium include magnetic media such as hard disks, floppy disks, and magnetic tapes, optical media such as CD-ROMs and DVDs, magneto-optical media such as floptical disks, and hardware devices, such as ROMs, RAMs, and flash memories, which are specially designed to store and execute program commands. The medium may be a transmission medium such as an optical fiber, a metal wire and a waveguide, which includes carrier waves that transmits signals for defining program commands or data structures. Examples of the program commands include an advanced language code which the computer can execute using an interpreter as well as a machine language code made by compilers. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for processing metadata, the apparatus comprising:
a map node defining component configured to define a map node for setting a virtual map;
a map overlay node defining component configured to define a map overlay node for setting a layer in which an augmented reality object is to be overlaid on a map set according to the map node defined by the map node defining component;
a map marker node defining component configured to define a map marker node for setting a position of the augmented reality object on the map, which is to be overlaid on the layer set according to the map overlay node defined by the map overlay node defining component;
a point of interest node defining component configured to set information on a point of interest, which is a position of the augmented reality object on the map; and
a controller configured to load the virtual map according to the map node defined by the map node defining component, load the layer according to the map overlay node defined by the map overlay node defining component, load the map marker according to the map marker node defined by the map marker node defining component, and load the point of interest according to the point of interest node defined by the point of interest node defining component.

2. The apparatus of claim 1, wherein the point of interest node defining component defines the point of interest node for setting information on the point of interest, which includes one or more of the following: whether a point of interest node is activated, a 3D vector value that represents a location of the point of interest, a radius of detection, a category of the point of interest, a name of the point of interest, a phone number of the point of interest, an email address of the point of interest, a list of providers of one or more of the point of interest, a registered time of the point of interest, a number of web resources that provide all types of information associated with the point of interest, a rating of the point of interest, a total number of ratings of the point of interest, information related to the point of interest, metadata of the point of interest, a number of the point of interest filtered, a set value of error occurrence when the filtering.

3. The apparatus of claim 1, further comprising:
a map marker metadata storage configured to store, as metadata, information on the position of the augmented reality object on a map, which is to be overlaid; and
a user preference information metadata storage configured to receive input of information on a user preference from a user input device and to store the received information as metadata,
wherein the controller generates a map marker by using the map marker metadata stored in the map marker metadata storage and using the user preference information metadata stored in the user preference information metadata storage, and to load the generated map marker.

4. The apparatus of claim 3, wherein the map marker metadata comprises one or more of the following: information that indicates a name of the map marker, information on latitude, longitude, and altitude of the map marker, an email addresses of the position of the map marker, details of the map marker, providers of the map marker metadata, production dates of the map marker metadata, resources to represent the map marker as media, and information indicative of containers to include standards related to conventional points of interest.

5. The apparatus of claim 3, wherein the user preference metadata comprises one or more of the following: information that indicates a radius within which an augmented reality object is to be displayed with the user on its center, information on a category of the point of interest desired by the user, information on a mode preferred by the user for representing the map, information on a media type of the augmented reality object desired by the user, information on a maximum number of the augmented reality object to be displayed on a screen of the user, and information on a zoom level of the map selected by the user.

6. The apparatus of claim 3, wherein the map node includes a user preference information field.

7. The apparatus of claim 6, wherein the map node sets one or more of the zoom level of the map and the mode of the map by reference to the stored user preference information metadata in the user preference information field.

8. The apparatus of claim 3, wherein the map overlay node includes one or more of the user preference information field and the point of interest metadata field.

9. The apparatus of claim 8, wherein the map overlay node sets one or more of attributions of visibility and clickability of the map marker by reference to the stored user preference information metadata in the user preference information field.

10. The apparatus of claim 8, wherein the map overlay node sets the map marker by reference to the stored map marker metadata in the point of interest metadata field.

11. The apparatus of claim 3, wherein the map marker node includes one or more of a map marker update field and an updateVisible field.

12. The apparatus of claim 11, wherein the map marker node updates the map marker by reference to the stored map marker metadata in the map marker update field.

13. The apparatus of claim 11, wherein the map marker node sets a visibility attribution of the map marker by reference to the stored user preference information metadata in the updateVisible field.

14. A method for processing metadata, the method comprising:
defining a map node for setting a virtual map;
defining a map overlay node for setting a layer in which an augmented reality object is to be overlaid on a map set according to the defined map node;
defining a map marker node for setting a position of the augmented reality object on the map, which is to be overlaid on the layer set according to the defined map overlay node;
defining a point of interest node for setting information on a point of interest, which is a position of the augmented reality object on the map; and
loading the virtual map according to the defined map node, loading the layer according to the defined map overlay node, loading the map marker according to the defined map marker node, and loading the point of interest according to the defined point of interest node.

15. The method of claim 14, further comprising:
storing, as metadata, information on the position of the augmented reality object on a map, which is to be overlaid;
receiving input of information on a user preference from a user input device, and storing the received information as metadata; and
generating a map marker by using the stored map marker metadata and the stored user preference information metadata, and loading the generated map marker.

16. The method of claim 15, wherein the map node includes a user preference information field and sets one or more of a zoom level of the map and a mode of the map by reference to the stored user preference information metadata in the user preference information field.

17. The method of claim 15, wherein the map overlay node includes the user preference information field, and sets one or more of attributions of visibility and clickability of the map marker by reference to the stored user preference information metadata in the user preference information field.

18. The method of claim 15, wherein the map overlay node includes the point of interest metadata field, and sets the map marker by reference to the stored map marker metadata in the point of interest metadata field.

19. The method of claim 15, wherein the map marker node includes a map marker update field, and updates the map marker by reference to the stored map marker metadata in the map marker update field.

20. The method of claim 15, wherein the map marker node includes an updateVisible field, and sets a visibility attribution of the map marker by reference to the stored user preference information metadata in the updateVisible field.
